(19) United States
(12) Patent Application Publication
(10) Pub. No.: US 2017/0094076 A1
(43) Pub. Date: Mar. 30, 2017

(54) IMAGE PROCESSING DEVICE, IMAGE PROCESSING METHOD, AND NON-TRANSITORY COMPUTER READABLE MEDIUM

(71) Applicant: FUJI XEROX CO., LTD., Tokyo (JP)

(72) Inventors: Toshiaki Koue, Kanagawa (JP); Kengo Tokuchi, Kanagawa (JP)

(73) Assignee: FUJI XEROX CO., LTD., Tokyo (JP)

(21) Appl. No.: 14/996,980

(22) Filed: Jan. 15, 2016

(30) Foreign Application Priority Data
Sep. 30, 2015 (JP) 2015-194100

(51) Int. Cl. H04N 1/00; G06F 12/14; H04N 1/21

(52) U.S. Cl. CPC H04N 1/00339; H04N 1/2166; G06F 12/1408; H04N 2201/0094; H04N 2201/0062; H04N 2201/0036; G06F 2212/1052

(57) ABSTRACT

An image processing device includes a sensing unit that senses an external storage device connected from outside, wherein an internal non-volatile storage device is not used for image forming operations, and the external storage device sensed by the sensing unit is used for the image forming operations.

### CROSS-REFERENCE TO RELATED APPLICATIONS

This application is based on and claims priority under 35 USC 119 from Japanese Patent Application No. 2015-194100 filed Sep. 30, 2015.

### BACKGROUND

The present invention relates to an image processing device, an image processing method, and a non-transitory computer-readable medium.

### SUMMARY

According to an aspect of the invention, there is provided an image processing device including a sensing unit that senses an external storage device connected from outside, wherein an internal non-volatile storage device is not used for image forming operations, and the external storage device sensed by the sensing unit is used for the image forming operations.

### BRIEF DESCRIPTION OF THE DRAWINGS

An exemplary embodiment of the present invention will be described in detail based on the following figures, wherein:

FIG. 1 is a schematic module configuration diagram for an exemplary configuration according to an exemplary embodiment;

FIG. 2 is a block diagram illustrating an exemplary hardware configuration that realizes an exemplary embodiment;

FIG. 3 is a schematic module configuration diagram for an exemplary configuration of an external hard disk connection module;

FIG. 4 is an explanatory diagram illustrating an exemplary system configuration utilizing an exemplary embodiment;

FIG. 5 is a flowchart illustrating an exemplary process according to an exemplary embodiment;

FIG. 6 is an explanatory diagram illustrating an example display according to an exemplary embodiment;

FIG. 7 is an explanatory diagram illustrating an example display according to an exemplary embodiment;

FIG. 8 is an explanatory diagram illustrating an example display according to an exemplary embodiment;

FIG. 9 is a flowchart illustrating an exemplary process according to an exemplary embodiment;

FIG. 10 is a flowchart illustrating an exemplary process according to an exemplary embodiment; and

FIG. 11 is a flowchart illustrating an exemplary process according to an exemplary embodiment.

### DETAILED DESCRIPTION

Hereinafter, an exemplary embodiment related to realizing the present invention will be described by way of example on the basis of the drawings.

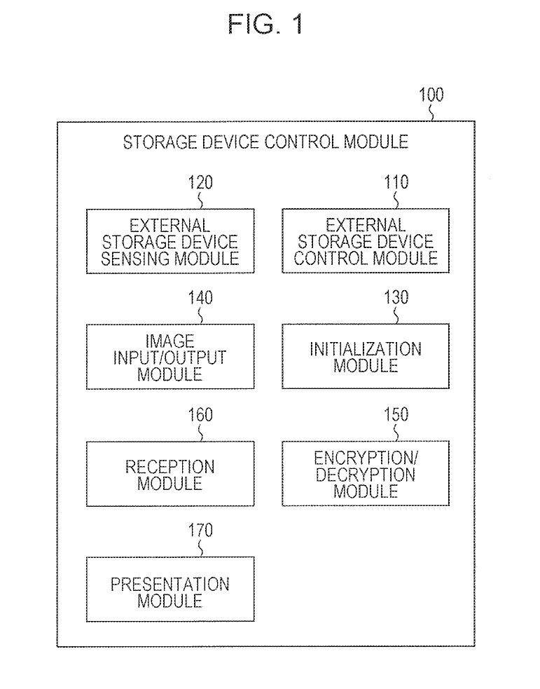

FIG. 1 illustrates a schematic module configuration for an exemplary configuration according to the exemplary embodiment.

Note that the term module refers to components such as software (computer programs) and hardware which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “device” not only encompass configurations in which multiple computers, hardware, or devices are connected by a communication medium such as a network (including connections that support 1-to-1 communication), but also encompass configurations realized by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random access memory (RAM), an auxiliary or external storage medium, a storage device accessed via a communication link, and a register or the like inside a central processing unit (CPU).

The storage device control module 100 according to the present exemplary embodiment treats an external storage device brought or the like by the user as a storage device to use for image forming operations. As illustrated by the example of FIG. 1, the storage device control module 100 includes an external storage device control module 110, an external storage device sensing module 120, an initialization module 130, an image input/output module 140, an encryption/decryption module 150, a reception module 160, and a presentation module 170.

Recently, the usage and market for rental offices has been growing. Rental offices are being used as a highly effective means of minimizing investment in teleconferencing systems and the like, and shortening the relocation time for assembling members from many base locations in one place.

Since a rental office is used by multiple people (or multiple businesses), security is a concern.

For example, most people bring their own electronic equipment such as personal computers to use inside a rental office, since other people will be using the room later.

However, image processing devices such as multifunction devices (image processing devices including any of two or more functions, such as scanner, printer, copier, and fax machine functions) are not easily portable, and thus bringing an image processing device to a rental office for installation and use is difficult.

Additionally, if an image processing device is installed in a rental office in advance and made available for use, image data and the like may be stored in a storage device inside the image processing device, and there is a possibility that such data may be leaked. For this reason, there are concerns about installing and using an image processing device in a rental office.

Typically, a hard disk is one component constituting an image processing device such as a multifunction device. The hard disk stores image data of a document scanned with a scanner provided in an image processing device, stores electronic documents for printing which have been transmitted from a personal computer or the like, and is used when conducting various image forming processes and outputting printed material.

Recently, security concerns have intensified over such images and data left over on a hard disk after being used as above, and such data may be encrypted or the like when stored on the hard disk.

Additionally, some image processing devices have acquired (conform to) ISO 15408 certification. When such an image processing device erases an image stored on the hard disk, the data is overwritten with zero data multiple times to ensure complete erasure of data or images on the hard disk.

However, the data or images to which the erasure process is applied are merely the stored documents, whereas various information related to the stored documents is not processed. For example, information such as file names, document names, the number of documents, destination names (destination addresses), source names (source addresses), and communication times are not subjected to the erasure process.

In other words, even if the actual document data is erased, data enabling these documents to be inferred (the various data above) is still left stored on the hard disk.

In addition, since acquiring ISO 15408 certification is costly and time-consuming, the acquisition of the certification itself is difficult.

Furthermore, in recent years, solid-state drives (SSDs) and SD memory cards are frequently being used instead of hard disks. On these media, memory is accessed according to a non-sequential method by a controller built into the SSD or SD memory card. Consequently, even adhering to the specifications of ISO 15408 discussed earlier may be difficult, and it is difficult to completely erase image data by control on the application side.

The external storage device control module 110 controls the use of an external storage device sensed by the external storage device sensing module 120 as the storage device to utilize for image forming operations. Herein, “image forming operations” include image processing conducted inside the image processing device. For example, one operation may convert image data read by the image processing device to enable output to an imaging unit (also called a printing unit). Such an operation is also called a copy process. Specifically, processes such as enlargement, reduction, and noise removal correspond to the above operation. Particularly, one operation may convert image data received by the image processing device to enable output to an imaging unit. Such an operation is also referred to as the process of an image forming operation for printout. Utilizing an external storage device for image forming operations may include not only storing the images themselves, but also information such as file names, document names, the number of documents, destination names (destination addresses), source names (source addresses), and communication times (which may be the year, month, day, hour, minute, second, fraction of a second, or some combination thereof). In addition, the external storage device may also be used to store data that is currently being processed. Furthermore, utilizing an external storage device for image forming operations may also include storing logs of image forming operations. Herein, logs of image forming operations may include not only a process log, but also results produced partway through the processing of the image forming operations, information in a storage area used as a work area, and the like.

In addition, the external storage device control module 110 utilizes the external storage device sensed by the external storage device sensing module 120 for image forming operations, without utilizing an internal (specifically, internal to the image processing device), non-volatile storage device. Herein, a non-volatile storage device refers to a storage device capable of retaining stored content even when no power is supplied. Note that an internal volatile storage device may also be utilized for image forming operations in addition to the external storage device. Herein, a volatile storage device refers to a storage device that does not retain stored information if power is no longer supplied. Consequently, by turning off the power, information utilized for image forming operations (such as an image scanned with a scanner, for example) does not remain in the image processing device, and is only retained on the external storage device.

The external storage device control module 110 may also make an external storage device unavailable for use for image forming operations if the external storage device has not been initialized by the initialization module 130. With this process, an uninitialized external storage device may not be activated or used.

When storing an image on the external storage device, the external storage device control module 110 may also control the encryption/decryption module 150 to conduct an encryption process. Note that the encryption process may be conducted continuously or according to an instruction by an operator. Alternatively, the encryption process may be conducted when the processing time for processing an image forming operation is shorter, or less than or equal to, predetermined threshold value. Obviously, when retrieving an image from the external storage device, the external storage device control module 110 may also control the encryption/decryption module 150 to conduct a decryption process.

If an external storage device is not sensed by the external storage device sensing module 120, the external storage device control module 110 may also apply control to not activate the image processing device (the image processing device housing the storage device control module 100).

If the image processing device is activated without an external storage device being sensed by the external storage device sensing module 120, the external storage device control module 110 may also control the presentation module 170 to present a display informing the operator to connect an external storage device.

The external storage device control module 110 may also apply control so that only an external storage device sensed by the external storage device sensing module 120 is used as the storage device to utilize for image forming operations. In this case, the internal volatile storage device discussed earlier is also not used for image forming operations, and only the external storage device is used. Consequently, it is possible to keep images and the like from being stored on a storage device other than the external storage device.

Additionally, the external storage device control module 110 may also apply control so that only an external storage device sensed by the external storage device sensing module 120 is used as the storage device that stores a process log for image forming operations. In this case, the internal volatile storage device discussed earlier is also not used to store a process log for image forming operations, and only the external storage device is used. Consequently, it is possible to keep a process log for image forming operations from being stored on a storage device other than the external storage device.

If an internal storage device built into the image processing device is being used as the storage device to utilize for image forming operations, and an external storage device is sensed by the external storage device sensing module 120, the external storage device control module 110 may switch from the internal storage device to the external storage device as the storage device to utilize for image forming operations.

Also, if an external storage device is sensed by the external storage device sensing module 120, the external storage device control module 110 may prioritize usage of the external storage device over an internal storage device.

If an external storage device is sensed by the external storage device sensing module 120, the external storage device control module 110 may also apply control to utilize either the internal storage device or the external storage device according to an instruction by the operator.

If multiple external storage devices are sensed by the external storage device sensing module 120, the external storage device control module 110 may control the use of a predetermined external storage device as a save location for scanned images or a retrieval source for previously stored images.

The following are examples of the “predetermined external storage device” herein.

(1) If a first external storage device is sensed by the external storage device sensing module 120, and then a second external storage device is sensed, the second external storage device is treated as the “predetermined external storage device”.
(2) The external storage device connected to a specific connection cable (or connection site) is treated as the “predetermined external storage device”.

As a specific example of (1), in a situation in which an external storage device used for the processing of image forming operations is already connected, and an additional external storage device is connected, the additional external storage device is utilized as a save location for scan data or a retrieval source for print data. In other words, if multiple external storage devices are sensed by the external storage device sensing module 120, the external storage device control module 110 may control the use of the second and subsequently sensed external storage device as a save location for scanned images or a retrieval source for previously stored images.

If the external storage device sensed by the external storage device sensing module 120 is an external storage device of a predetermined type, the external storage device control module 110 may control the use of that external storage device as the storage device to utilize for image forming operations. The “predetermined type” may correspond to information indicating the manufacturer, model, serial number, or the like of the external storage device, for example. It is sufficient for the external storage device control module 110 stores these “predetermined types”, receive a notification of the manufacturer, model, serial number, or the like from the connected external storage device, and conduct a confirmation process.

The external storage device sensing module 120 senses an external storage device connected from the outside. Herein, the external storage device connected from the outside may be a hard disk, an SSD, an SD memory card, or the like. Note that although a non-volatile storage device is typically used as the external storage device, a volatile storage device is also acceptable. In the following description, a hard disk will be given as an example.

The initialization module 130 initializes an external storage device sensed by the external storage device sensing module 120. The timing of initialization may be when the external storage device is sensed by the external storage device sensing module 120, or when an instruction to perform initialization is received by the reception module 160 after the presentation module 170 presents a display by which the operator gives an instruction about whether or not to initialize the external storage device. Also, as discussed later, the external storage device may also be initialized when an operation for powering off or an operation for removing the external storage device is performed.

Note that initialization herein includes complete initialization, also referred to as formatting. By initializing the external storage device, it is possible to deter the installation of harmful programs such as viruses onto the image processing device.

The image input/output module 140 inputs and outputs data with respect to the external storage device, according to control by the external storage device control module 110. For example, the image input/output module 140 causes the external storage device to store images scanned by the scanner, outputs data stored on the external storage device to the printer, inputs and outputs data communicated by fax, and the like.

The encryption/decryption module 150 encrypts data to store in the external storage device according to control by the external storage device control module 110, and in the case of reading stored data, decrypts the data (decryption corresponding to the encryption). For the encryption process and the decryption process, it is sufficient to use established technology. Additionally, the encryption/decryption module 150 may also compress data to store in the external storage device according to control by the external storage device control module 110, and in the case of reading stored data, decompress the data (decompression corresponding to the compression).

The reception module 160 receives operations on the external storage device by an operator via a user interface (a touch panel, buttons, or the like) of the image processing device. The operations to receive may include an operation indicating whether or not to initialize the external storage device, for example.

The presentation module 170 presents a display related to the external storage device via a user interface (a liquid crystal display, touch panel, or the like) of the image processing device. For example, when an external storage device is sensed by the external storage device sensing module 120, a display enabling the operator to indicate whether or not to initialize that external storage device (such as an initialization button, for example) is presented on a display device.

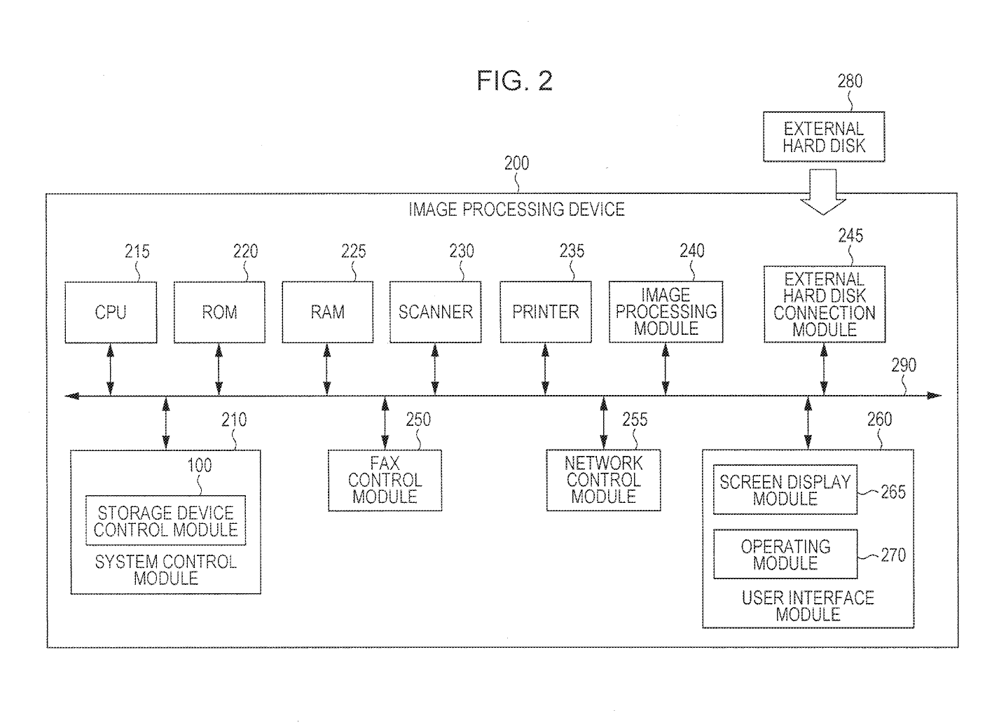

FIG. 2 is a block diagram illustrating an exemplary hardware configuration that realizes an exemplary embodiment.

The image processing device 200 includes a system control module 210, a CPU 215, ROM 220, RAM 225, a scanner 230, a printer 235, an image processing module 240, an external hard disk connection module 245, a fax control module 250, a network control module 255, and a user interface module 260. These modules are connected to each other via an internal bus 290 (such as a Peripheral Component Interconnect/Interface (PCI) bus, for example).

The image processing device 200 is a device such as a multifunction device, a copier, a fax machine, a scanner, or a printer, for example.

The system control module 210 controls the image processing device 200 overall, and includes the storage device control module 100 that controls an external storage device (external hard disk connection module 245, external hard disk 280). The system control module 210 itself may control various modules, or store processing content (a computer program) to be executed by the CPU 215.

The CPU 215 is a control unit that executes processing according to a computer program stating an execution sequence for the various modules inside the image processing device 200.

The ROM 220 stores information such as computer programs and computational parameters used by the CPU 215.

The RAM 225 stores information such as computer programs used during execution by the CPU 215, and parameters that change as appropriate during such execution. Note that the RAM 225 is a volatile storage device in which stored data is lost when power is removed, and does not include what is called non-volatile memory (NVM).

The scanner 230 reads images. Such read images are stored in the external hard disk 280, or subjected to the processing of image forming operations by the image processing module 240.

The printer 235 prints images stored on the external hard disk 280.

The image processing module 240 conducts the processing of image forming operations on images read by the scanner 230, images stored in the external hard disk 280, and the like. Note that when conducting the processing of such image forming operations, partially processed data is stored using the external hard disk 280.

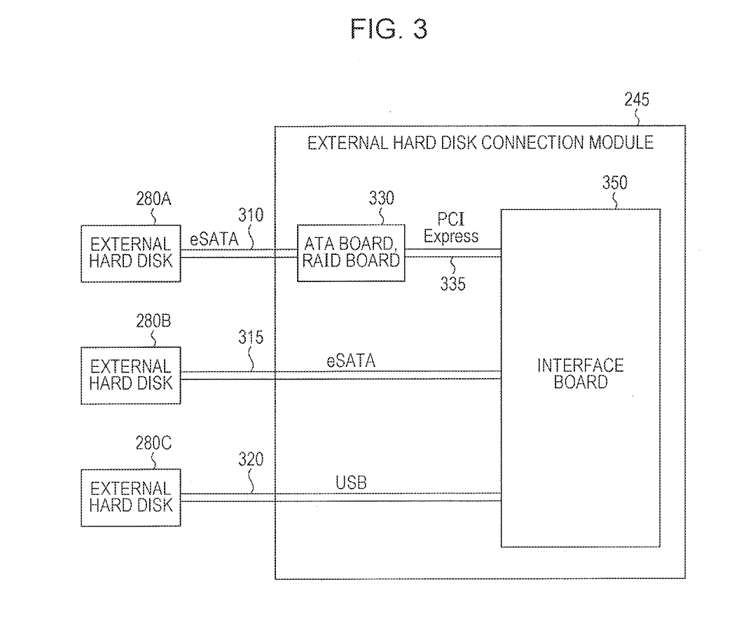

The external hard disk connection module 245 is a device that connects the external hard disk 280 to the image processing device 200, and may be realized as a connector, a cable, or the like. The external storage device sensing module 120 senses the connection of the external hard disk 280 to the external hard disk connection module 245. A configuration of the external hard disk connection module 245 will be discussed later using FIG. 3.

The fax control module 250 provides fax functionality, storing received images in the external hard disk 280, and transmitting images on the external hard disk 280.

The network control module 255 communicates with an external device via a communication link. At this point, the network control module 255 at least uses the external hard disk 280 for inputting and outputting images.

The user interface module 260 includes a screen display module 265 and an operating module 270. The screen display module 265 presents a display on a liquid crystal display, a touch panel, or the like according to instructions from the presentation module 170. The operating module 270 receives operations on operable buttons, a touch panel, a mouse, or the like by the operator, and passes received operations to the reception module 160.

Note that the hardware configuration of the image processing device 200 illustrated in FIG. 2 illustrates a single exemplary configuration, and that the exemplary embodiment is not limited to the configuration illustrated in FIG. 2 insofar as the configuration still enables execution of the modules described in the exemplary embodiment. For example, some modules may also be realized with special-purpose hardware (such as an application-specific integrated circuit (ASIC), for example), and some modules may be configured to reside within an external system and be connected via a communication link.

FIG. 3 is a schematic module configuration diagram for an exemplary configuration of the external hard disk connection module 245.

The external hard disk connection module 245 includes an ATA board, RAID board 330, and an interface board 350. Herein, an example in which three hard disks are connected is illustrated. The external hard disk 280A is connected to the ATA board, RAID board 330 via eSATA 310. Additionally, the ATA board, RAID board 330 is connected to the interface board 350 via PCI Express 335. The external hard disk 280B is connected to the interface board 350 via eSATA 315. The external hard disk 280C is connected to the interface board 350 via USB 320. The interface board 350 senses that an external hard disk 280 has been connected, and notifies the storage device control module 100. Additionally, the interface board 350 also senses the disconnection of an external hard disk 280, and notifies the storage device control module 100. In addition, the interface board 350 inputs and outputs data with respect to the external hard disk 280 according to control by the storage device control module 100.

Note that it is sufficient to be able to connect one or more hard disks. Additionally, in the case of connecting multiple hard disks, the ATA board, RAID board 330 may be used to configure a redundant array of inexpensive disks (RAID array). Also, as discussed earlier, devices such as SSDs and SD memory cards may be used instead of hard disks.

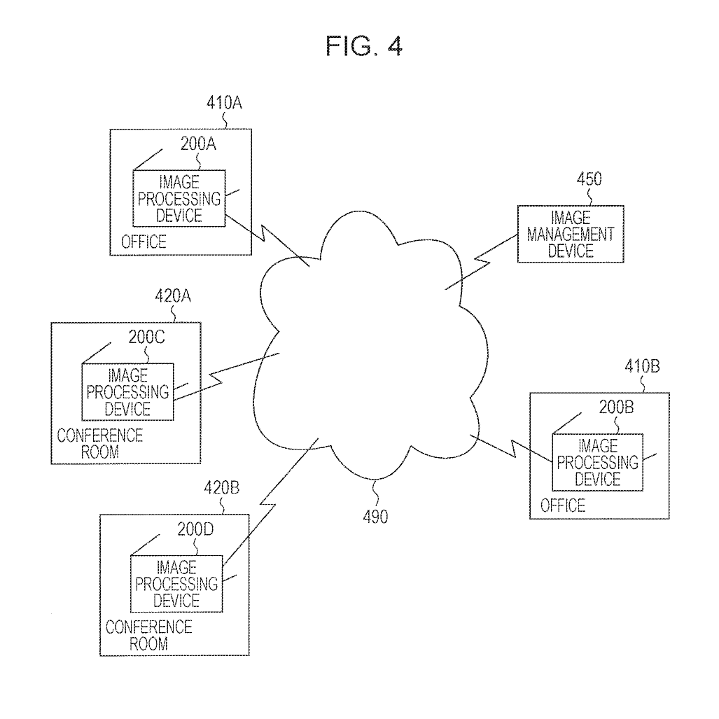

FIG. 4 is an explanatory diagram illustrating an exemplary system configuration utilizing an exemplary embodiment.

An image processing device 200A, an image processing device 200b, an image processing device 200C, an image processing device 200D, and an image management device 450 are connected to each other via a communication link 490. The communication link 490 may be wireless, wired, or a combination of the two, and may use a network such as the Internet or an intranet as a communication infrastructure, for example.

The image processing device 200A is installed in an office 410A. The image processing device 200B is installed in an office 410B. The image processing device 200C is installed in a conference room 420A. The image processing device 200D is installed in a conference room 420B. The offices 410 are what are called rental offices, and as discussed earlier, since rental offices are used by multiple people, leaving leftover data in the image processing device 200 is undesirable from a security standpoint. Likewise, the conference rooms 420 are also used by multiple people, and thus leaving leftover data in the image processing device 200 is undesirable from a security standpoint. The storage device control module 100 is built into the image processing device 200, and the image processing device 200 is used by connecting to the image processing device 200 a hard disk brought in by a user of the office 410 or the conference room 420. Subsequently, when the user has finished using the office 410 or conference room 420, the user takes the hard disk home, and thus leftover image data or the like does not remain in the image processing device 200. Note that when intending to distribute image data read in by the image processing device 200 to participants, for example, the image processing device 200 may transmit the image data to the image management device 450, and each participant may acquire the image data from the image management device 450. Obviously, communication between the image processing device 200 and the image management device 450 is conducted in a secure environment. The functions provided by the image management device 450 may also be realized as a cloud service.

Specifically, the following processes are conducted, for example.

(1) A user of the office 410 or conference room 420 brings an external hard disk 280. Note that the external hard disk 280 may also be lent out (for free or for pay) by an administrator of the office 410 or the conference room 420.
(2) The user connects (installs) the external hard disk 280 at a predetermined location on the image processing device 200.
(3) The user powers on the image processing device 200.
(4) The storage device control module 100 senses the connection of the external hard disk 280, displays an initialization button on the touch panel of the image processing device 200, and subsequently waits for the initialization button to be pressed.
(5) The user presses the initialization button. Note that if the initialization button is not pressed, various jobs are not activated or processed.
(6) After initialization of the external hard disk 280, the image processing device 200 reboots.
(7) The image processing device 200 presents an idle display (such as a display indicating “Ready to copy”).
(8) In the image processing device 200, various jobs (such as copy jobs, scan jobs, print jobs, and fax jobs) are activated and processed according to user operations.
(9) The user powers off the image processing device 200.
(10) The user unplugs (removes) the external hard disk 280 from the image processing device 200.

Note that when the user desires to perform initialization intentionally when taking the external hard disk 280 home, (3) to (5) above may be executed after the process of (9) above. In addition, when an operation for powering off is performed, (4) and (5) may be executed before actually conducting the power-off process, and after initialization, the power-off process may be conducted. Note that when an operation for unplugging the external hard disk 280 is performed before powering off, (4) and (5) may be executed at that point, and after initialization, a display indicating that the external hard disk 280 may be unplugged may be presented.

If an external hard disk 280 that has been used previously by the image processing device 200 (a formatted hard disk) is reconnected, the external hard disk 280 may be used as-is. In this case, during initialization, information indicating that the external hard disk 280 has been initialized by that image processing device 200 (including a unique number of the image processing device 200 or the like) may be stored on the external hard disk 280. Subsequently, during initialization, if the information indicating that the external hard disk 280 has been initialized is stored on the external hard disk 280, that external hard disk 280 may be used without performing initialization again.

However, since security risks and problems are a possibility, it is desirable to perform initialization every time. For example, if an external hard disk 280 is used once by the image processing device 200 and then subsequently used with another information processing device, there is a possibility of becoming infected with a virus. There is also a possibility of intentionally inserting a mechanism of forwarding data or image information stored on the external hard disk 280 to a specific destination or the like. Additionally, there is also a possibility that another person may pick up, steal, or copy the external hard disk 280. In other words, it is desirable to perform initialization every time the external hard disk 280 is connected to the image processing device 200.

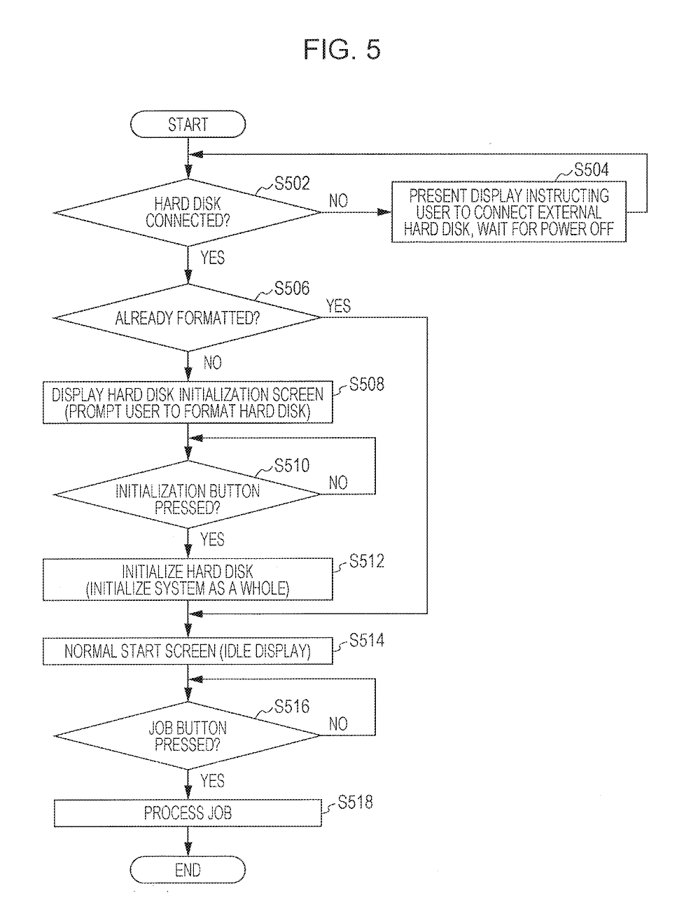

FIG. 5 is a flowchart illustrating an exemplary process according to the exemplary embodiment.

In step S502, it is determined whether or not a hard disk is connected, and if connected, the process proceeds to step S506. Otherwise, the process proceeds to step S504.

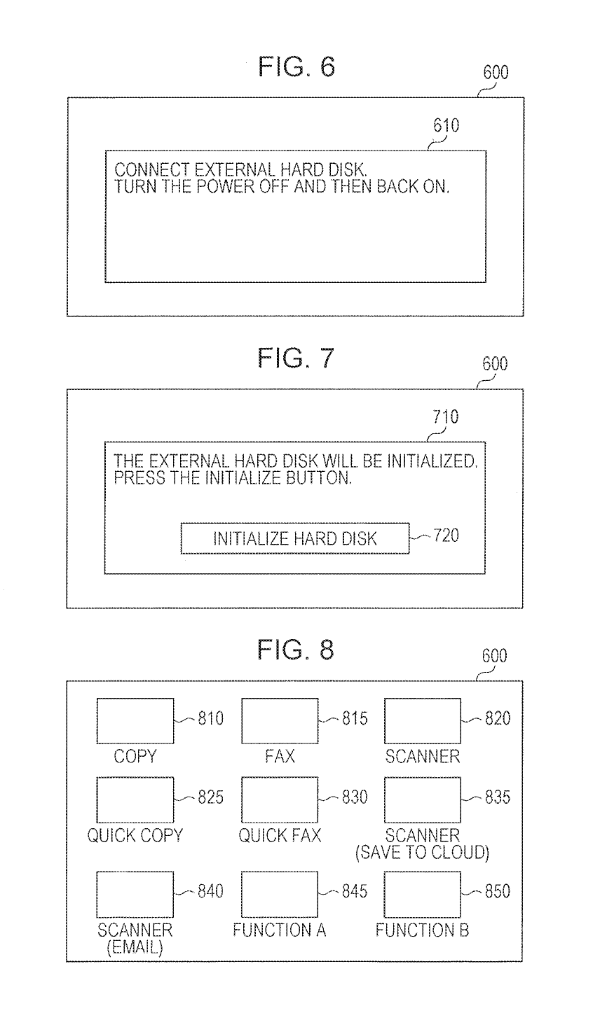

In step S504, a display instructing the user to connect an external hard disk is presented, and the process waits for power off. After that, the process proceeds to step S502. For example, a message screen 610 as illustrated in FIG. 6 is displayed on a screen 600 provided on the image processing device 200. On the message screen 610, the message “Connect external hard disk. Turn the power off and then back on.” is displayed.

In step S506, it is determined whether or not the external hard disk is already formatted, and if already formatted, the process proceeds to step S514. Otherwise, the process proceeds to step S508.

In step S508, a hard disk initialization screen is displayed (prompting the user to format the hard disk). For example, a message screen 710 as illustrated in FIG. 7 is displayed on the screen 600. On the message screen 710, the message “The external hard disk will be initialized. Press the initialize button.” is displayed, and an “Initialize hard disk” button 720 is displayed.

In step S510, it is determined whether or not the initialize button was pressed, and if pressed, the process proceeds to step S512. Otherwise, the process stands by until the initialize button is pressed.

In step S512, the hard disk is initialized (the system as a whole is initialized).

In step S514, a normal start screen (idle display) is displayed. For example, the screen 600 as illustrated in FIG. 8 is displayed. On the screen 600, job buttons for specifying jobs processible by the image processing device 200, such as Copy 810, Fax 815, Scanner 820, Quick Copy 825, Quick Fax 830, Scanner (save to cloud) 835, Scanner (email) 840, Function A 845, and Function B 850, are displayed.

In step S516, it is determined whether or not a job button was pressed, and if pressed, the process proceeds to step S518. Otherwise, the process stands by until a job button is pressed. The normal start screen (job reception screen) is displayed, and the image processing device 200 waits for the operator to activate jobs (such as copy, scan, or fax). If activated, each job is executed.

In step S518, a job is processed.

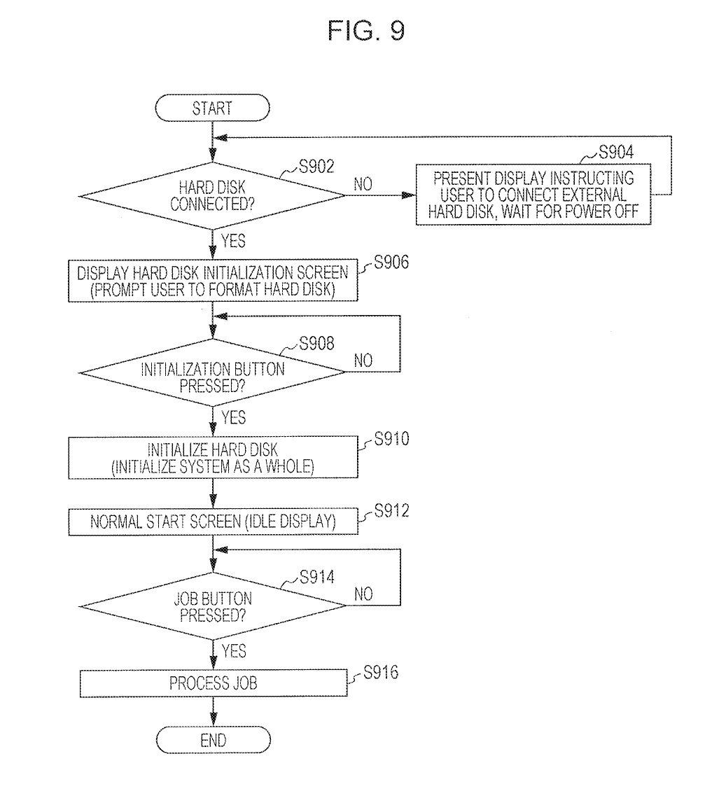

FIG. 9 is a flowchart illustrating an exemplary process according to the exemplary embodiment. This process does not check whether or not a disk is formatted like in the flowchart (step S506) illustrated by the example of FIG. 5, and instead always performs initialization.

In step S902, it is determined whether or not a hard disk is connected, and if connected, the process proceeds to step S906. Otherwise, the process proceeds to step S904.

In step S904, a display instructing the user to connect an external hard disk is presented, and the process waits for power off. After that, the process proceeds to step S902.

In step S906, a hard disk initialization screen is displayed (prompting the user to format the hard disk).

In step S908, it is determined whether or not the initialize button was pressed, and if pressed, the process proceeds to step S910. Otherwise, the process stands by until the initialize button is pressed.

In step S910, the hard disk is initialized (the system as a whole is initialized).

In step S912, a normal start screen (idle display) is displayed.

In step S914, it is determined whether or not a job button was pressed, and if pressed, the process proceeds to step S916. Otherwise, the process stands by until a job button is pressed. The normal start screen (job reception screen) is displayed, and the image processing device 200 waits for the operator to start a job (such as copy, scan, or fax). If activated, each job is executed.

In step S916, a job is processed.

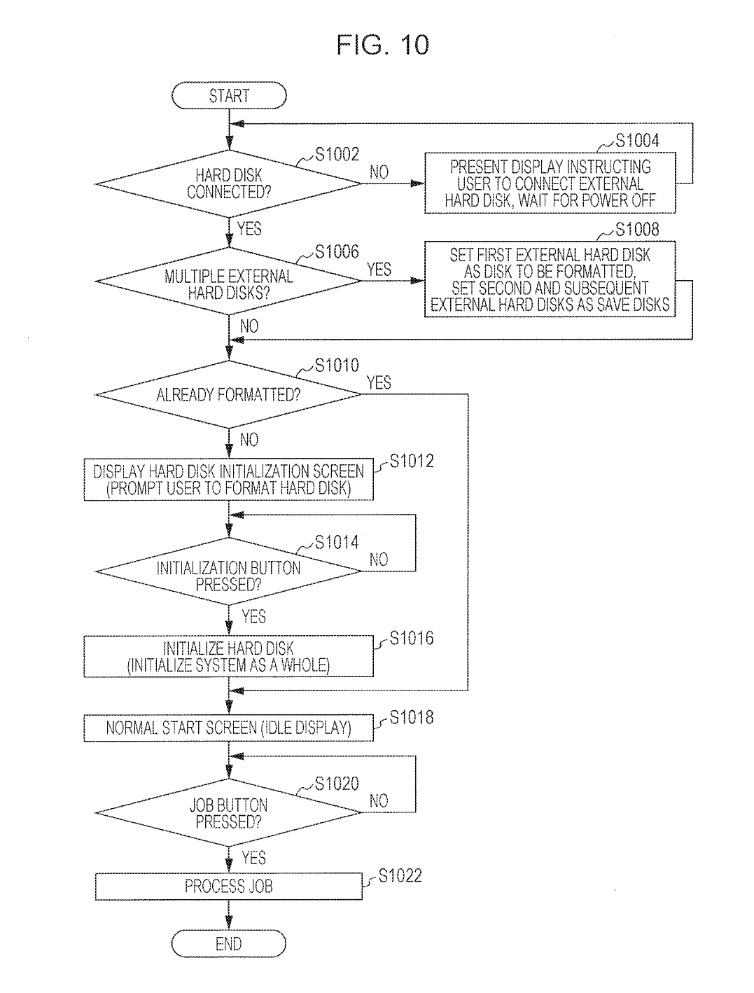

FIG. 10 is a flowchart illustrating an exemplary process according to the exemplary embodiment. The flowchart in FIG. 10 illustrates an example process in the case of connecting multiple hard disks.

In step S1002, it is determined whether or not a hard disk is connected, and if connected, the process proceeds to step S1006. Otherwise, the process proceeds to step S1004.

In step S1004, a display instructing the user to connect an external hard disk is presented, and the process waits for power off. After that, the process proceeds to step S1002.

In step S1006, it is determined whether or not there are multiple external hard disks, and if there are multiple external hard disks, the process proceeds to step S1008. Otherwise, the process proceeds to step S1010.

In step S1008, the first external hard disk is set as the disk to be formatted, while the second and subsequent external hard disks are set as disks used for saving. After that, the process proceeds to step S1010. Herein, the first external hard disk becomes the storage device used for image forming operations. The second external hard disk may not be treated as a disk to be formatted, and may be used to store image data read by the scanner, or as a source from which to print previously stored data. Note that although this example treats the external hard disk that was connected first as the disk to be formatted, the external hard disk connected last may also be treated as the disk to be formatted. Alternatively, instead of the connection order, the external hard disk connected to a predetermined cable may be treated as the disk to be formatted.

In step S1010, it is determined whether or not the external hard disk is already formatted, and if already formatted, the process proceeds to step S1018. Otherwise, the process proceeds to step S1012. The process may also not check whether the external hard disk is formatted, and always perform initialization.

In step S1012, a hard disk initialization screen is displayed (prompting the user to format the hard disk).

In step S1014, it is determined whether or not the initialize button was pressed, and if pressed, the process proceeds to step S1016. Otherwise, the process stands by until the initialize button is pressed.

In step S1016, the hard disk is initialized (the system as a whole is initialized).

In step S1018, a normal start screen (idle display) is displayed.

In step S1020, it is determined whether or not a job button was pressed, and if pressed, the process proceeds to step S1022. Otherwise, the process stands by until a job button is pressed. The normal start screen (job reception screen) is displayed, and the image processing device 200 waits for the operator to start a job (such as copy, scan, or fax). If activated, each job is executed.

In step S1022, a job is processed.

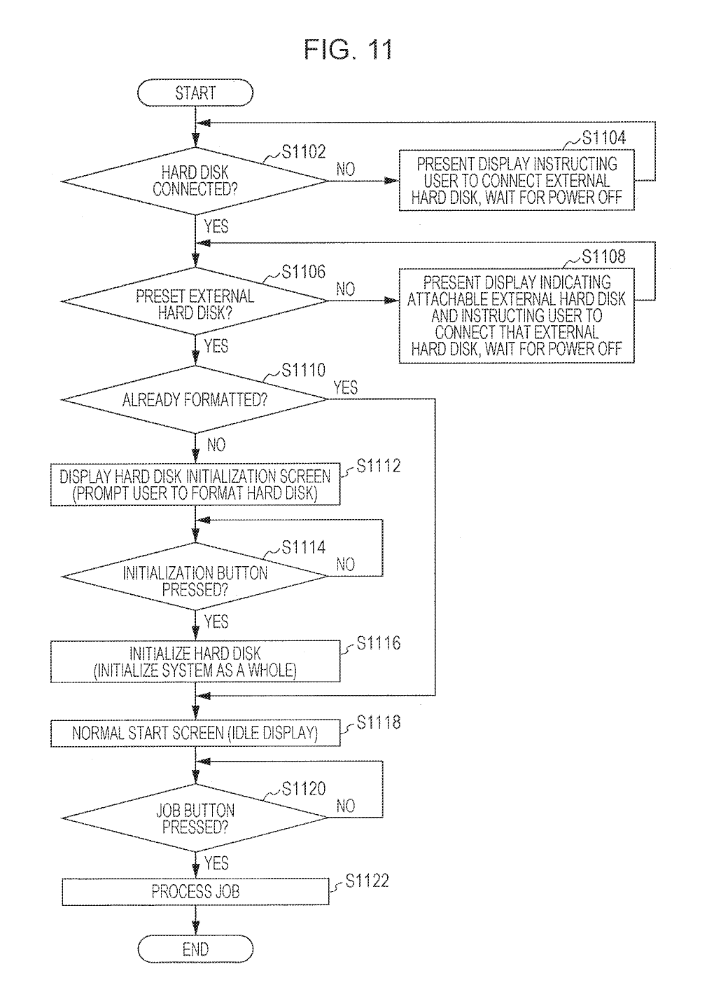

FIG. 11 is a flowchart illustrating an exemplary process according to the exemplary embodiment. This process confirms that an external hard disk processible by the image processing device 200 is connected.

In step S1102, it is determined whether or not a hard disk is connected, and if connected, the process proceeds to step S1106. Otherwise, the process proceeds to step S1104.

In step S1104, a display instructing the user to connect an external hard disk is presented, and the process waits for power off. After that, the process proceeds to step S1102.

In step S1106, it is determined whether or not the connected external hard disk is a preset external hard disk. If the preset external hard disk is connected, the process proceeds to step S1110. Otherwise, the process proceeds to step S1108. This determination judges whether or not the external hard disk is compatible with the image processing device 200.

In step S1108, a display indicating the attachable external hard disk and instructing the user to connect that external hard disk is presented, and the process waits for power off. After that, the process proceeds to step S1106. A display listing external hard disks which are compatible with the image processing device 200 is presented.

In step S1110, it is determined whether or not the external hard disk is already formatted, and if already formatted, the process proceeds to step S1118. Otherwise, the process proceeds to step S1112. The process may also not check whether the external hard disk is formatted, and always perform initialization.

In step S1112, a hard disk initialization screen is displayed (prompting the user to format the hard disk).

In step S1114, it is determined whether or not the initialize button was pressed, and if pressed, the process proceeds to step S1116. Otherwise, the process stands by until the initialize button is pressed.

In step S1116, the hard disk is initialized (the system as a whole is initialized).

In step S1118, a normal start screen (idle display) is displayed.

In step S1120, it is determined whether or not a job button was pressed, and if pressed, the process proceeds to step S1122. Otherwise, the process stands by until a job button is pressed. The normal start screen (job reception screen) is displayed, and the image processing device 200 waits for the operator to start a job (such as copy, scan, or fax). If activated, each job is executed.

In step S1122, a job is processed.

Note that the following process may also be conducted as the process when usage of the image processing device 200 has ended, such as when a conference ends.

In the case of sensing that the external hard disk 280 has been disconnected, the image processing device 200 may be forcibly powered off. This is because a power-off eliminates the data inside the RAM 225, a volatile storage device.

Also, the storage device control module 100 may receive information about the end time of the usage of the office 410 or the conference room 420 from a management device (scheduler) of the office 410 or the conference room 420, and when the end time (or a predetermined time before the end time (such as 5 minutes before, for example)) is reached, an alarm (such as a display, sound, or vibration) indicating to remove the external hard disk 280 may be produced.

In addition, the image processing device 200 may include a sensor (such as a light sensor or a lighting device power sensor) that senses whether or not the lights are on in the room of the office 410 or the conference room 420, and if the sensor senses that the lights are on, the image processing device 200 may produce an alarm indicating to remove the external hard disk 280.

Note that the described program may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

The recording medium may be a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), or a Secure Digital (SD) memory card, for example.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), an internet, an intranet, an extranet, or some combination thereof, or alternatively, by being modulated onto a carrier wave and propagated.

Furthermore, the above program may be part of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image processing device comprising:
at least one hardware processor configured to implement:
an internal non-volatile storage device;
a sensing unit that senses an external storage device connected to the image processing device from outside of the image processing device; and
in response to detecting that the external storage device has been in a formatted state after being sensed by the sensing unit, controlling image forming operations such that:
the internal non-volatile storage device is not used for the image forming operations, and
the external storage device sensed by the sensing unit is used for the image forming operations.

2. The image processing device according to claim 1, wherein the at least one hardware processor is further configured to implement:
a display unit that, in a case of an external storage device being sensed by the sensing unit, presents, on a display device, a display enabling an operator to indicate whether to initialize the external storage device.

3. The image processing device according to claim 1, wherein the at least one hardware processor is further configured to implement:
an initialization unit that initializes the external storage device sensed by the sensing unit, wherein
if the external storage device has not been initialized by the initialization unit, the external storage device is made unavailable for use with the image forming operations.

4. The image processing device according to claim 1, wherein
an encryption process is made to be conducted in a case of storing an image on the external storage device.

5. The image processing device according to claim 1, wherein
the image processing device is made to not activate if an external storage device is not sensed by the sensing unit.

6. The image processing device according to claim 1, wherein
in a case of the image processing device being activated without an external storage device sensed by the sensing unit, a display indicating to connect an external storage device is made to be presented.

7. The image processing device according to claim 1, wherein
only the external storage device sensed by the sensing unit is made to be used as a storage device used for image forming operations.

8. (canceled)

9. The image processing device according to claim 1, wherein the at least one hardware processor is further configured to implement:
use of the internal storage device for the image forming operations in response to an operator instruction.

10. The image processing device according to claim 1,
in a case of a plurality of external storage devices being sensed by the sensing unit, a predetermined external storage device is made to be used as a save location for read images or a retrieval source for previously stored images.

11. The image processing device according to claim 10, wherein
in a case of a plurality of external storage devices being sensed by the sensing unit, the second or subsequently sensed external storage device is made to be used as a save location for read images or a retrieval source for previously stored images.

12. The image processing device according to claim 1, wherein
in a case of an external storage device sensed by the sensing unit being an external storage device of a predetermined type, the external storage device is made to be treated as the storage device used for the image forming operations.

13. The image processing device according to claim 1, wherein
the image forming operations are operations of converting image data received by the image processing device to enable output of the image data to an imaging unit.

14. The image processing device according to claim 1, wherein
only the external storage device sensed by the sensing unit is made to be used as a storage device storing a process log for image forming operations.

15. An image processing method comprising:
sensing an external storage device connected to an image processing device from outside of the image processing device; and
in response to detecting that the external storage device has been in a formatted state after being sensed by the sensing unit, controlling image forming operations such that:
internal non-volatile storage device is not used for the image forming operations, and
the sensed external storage device is used for the image forming operations wherein
the internal non-volatile storage device is internal to the image processing device.

16. A non-transitory computer readable medium storing a program causing a computer to execute a process for processing an image, the process comprising:
sensing an external storage device connected to an image processing device from outside of the image processing device, wherein
in response to detecting an indication that the external storage device has been in a formatted state after being sensed by the sensing unit, controlling image forming operations such that:
the internal non-volatile storage device is not used for the image forming operations, and
the sensed external storage device is used for the image forming operations, wherein
the internal non-volatile storage device is internal to the image processing device.

17. The image processing device according to claim 1,
wherein the at least one hardware processor is further configured to implement:
requiring the external storage device to be formatted prior to being used for the image forming operations,
if the external storage device was in the formatted state after being sensed by the sensing unit and prior to being used for the image forming operations, storing an indication in the internal non-volatile storage device, and
if the indication is stored in the internal non-volatile storage device, further using the external storage device for the image forming operations, without requiring additional formatting of the external storage device, in a case in which the external storage device is disconnected from and reconnected to the image processing device.

18. The image processing device according to claim 1,
wherein the at least one hardware processor is further configured to implement:
using an internal volatile storage device for the image forming operations, the internal volatile storage device being configured to not retain any data regarding the image forming operations in response to a supply of power to the internal volatile storage device being removed.
